(19) United States
(12) Patent Application Publication
(10) Pub. No.: US 2020/0231808 A1
(43) Pub. Date: Jul. 23, 2020

(54) ADDITION-CURABLE SILICONE RUBBER COMPOSITION AND AIRBAG

(71) Applicant: SHIN-ETSU CHEMICAL CO., LTD., Tokyo (JP)

(72) Inventors: Hidenori MIZUSHIMA, Annaka-shi (JP); Shigeru UBUKATA, Annaka-shi (JP); Ryo ASHIDA, Annaka-shi (JP)

(73) Assignee: SHIN-ETSU CHEMICAL CO., LTD., Tokyo (JP)

(21) Appl. No.: 16/305,288

(22) PCT Filed: Aug. 10, 2017
(86) PCT No.: PCT/JP2017/029144

§ 371 Date: Nov. 28, 2018

(30) Foreign Application Priority Data
Aug. 26, 2016 (JP) 2016-165594

(51) Int. Cl. C08L 83/04; C08G 77/12; C08G 77/20; C08K 3/36; C08K 5/3492; C08K 5/56; B60R 21/235; D06N 3/12

(52) U.S. Cl. CPC C08L 83/04; C08G 77/12; C08G 77/20; C08K 3/36; C08K 5/34924; D06N 2211/268; B60R 21/235; D06N 3/128; C08L 2205/03; C08K 2201/006; C08K 5/56

(57) ABSTRACT

Provided is an addition-curable silicone rubber composition for airbags. An addition-curable silicone rubber composition which contains:
100 parts by mass of (A) an organopolysiloxane that contains two or more alkenyl groups in each molecule;
(B) a cyclic organohydrogenpolysiloxane represented by formula (1),

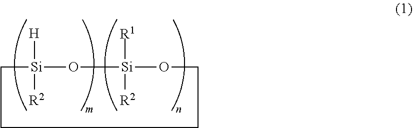

wherein the polysiloxane content is 50 mol % or more relative to the total amount of the component (B) when m=2;
(C) an organohydrogenpolysiloxane represented by formula (2),

R²ₑH_{f}SiO_{(4-e-f)/2} (2)

which contains two or more silicon atom-bonded hydrogen atoms in each molecule, in such an amount that the number of silicon atom-bonded hydrogen atoms in the components (B) and (C) is 1 to 7 per one silicon atom-bonded alkenyl group in the component (A) and the number of silicon atom-bonded hydrogen atoms in the component (B) is 1-30% of the number of silicon atom-bonded hydrogen atoms in the components (B) and (C);
0.1-50 parts by mass of (D) a fine silica powder having a BET specific surface area of 50 m²/g or more; and
an effective amount of (E) an addition reaction catalyst.

### TECHNICAL FIELD

This invention relates to airbags such as curtain airbags having a silicone rubber coating layer formed on textile fabric such as nylon 66 and a liquid addition-curable silicone rubber composition useful for the preparation of airbags.

### BACKGROUND ART

In the prior art, silicone rubber compositions for airbags are proposed for the purpose of forming a rubber coating on textile surface. For example, there are known an airbag-forming addition curable liquid silicone rubber composition comprising an inorganic filler, siloxane resin, and epoxy-containing silicon compound added, the composition having improved adhesion to base fabric (Patent Document 1); an addition curable liquid silicone rubber coating composition comprising an inorganic filler, siloxane resin, organotitanium compound and alkyl silicate added, the composition developing improved adhesion to base fabric by low-temperature brief heating (Patent Document 2); an airbag-forming silicone rubber composition comprising a vinyl-containing organopolysiloxane having a limited viscosity and having thin coating ability (Patent Document 3); and a rubber coating composition having added thereto wet silica having an average specific surface area of 150 to 250 m²/g as measured by the BET method and an average particle size of up to 20 μm, the composition being suitable for forming rubber coated textile with minimized tack (Patent Document 4).

Unlike the airbags mounted at driver and front seats, curtain airbags are mounted from the front pillar along the roof side and required to maintain inflation for a certain period of time for protecting the head or preventing ejection in collision or rollover incidents. When used in the preparation of curtain airbags, the aforementioned compositions are unsatisfactory in preventing leakage of inflator gas and sustaining inflation for a certain time.

### PRIOR ART DOCUMENTS

### Patent Documents

Patent Document 1: JP-A H05-214295

Patent Document 2: JP-A 2002-138249

Patent Document 3: JP-A 2001-287610

Patent Document 4: JP-A 2001-059052

### SUMMARY OF INVENTION

### Technical Problem

An object of the invention, which has been made under the above-mentioned circumstances, is to provide an airbag, typically curtain airbag capable of preventing leakage of inflator gas and sustaining inflation for some time, and a liquid addition-curable silicone rubber composition useful in preparing the same.

### Solution to Problem

Making extensive investigations to attain the above object, the inventors have reached the invention.

The invention provides an addition-curable silicone rubber composition and an airbag as defined below.

[1] An addition-curable silicone rubber composition comprising:

(A) 100 parts by weight of an organopolysiloxane having at least two C₂-C₈ alkenyl groups per molecule,

(B) a cyclic organohydrogenpolysiloxane having the formula (1):

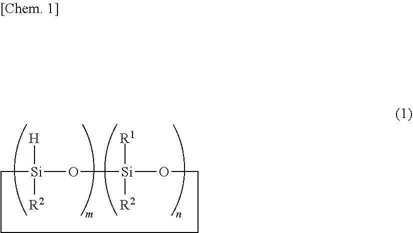

wherein R¹ is a C₁-C₁₂ alkyl group, R² is a C₁-C₁₂ alkyl group or C₆-C₁₂ aryl group, m is an integer of 1 to 3, n is an integer of 1 to 3, m+n is 4 or 5, the organohydrogenpolysiloxane of formula (1) wherein m=2 being present in an amount of at least 50 mol % based on the total amount of component (B),

(C) an organohydrogenpolysiloxane having at least two silicon-bonded hydrogen atoms per molecule, represented by the average compositional formula (2):

[Chem. 2]

R²ₑH_{f}SiO_{(4-e-f)/2} (2)

wherein R² is as defined above, e is a number of 0.7 to 2.1, f is a number of 0.001 to 1.0, e+f is a number of 0.8 to 2.7,

the amounts of components (B) and (C) blended being such that the total number of silicon-bonded hydrogen atoms in components (B) and (C) is 1 to 7 per silicon-bonded alkenyl group in component (A), and the number of silicon-bonded hydrogen atoms in component (B) is 1 to 30% based on the total number of silicon-bonded hydrogen atoms in components (B) and (C),

(D) 0.1 to 50 parts by weight of finely divided silica having a specific surface area of at least 50 m²/g as measured by the BET method, and

(E) a catalytic amount of an addition reaction catalyst.

[2] The addition-curable silicone rubber composition of [1], further comprising

(F) a tackifier, and

(G) at least one condensation catalyst selected from organotitanium compounds and organozirconium compounds.

[3] The addition-curable silicone rubber composition of [2] wherein component (F) contains an alkoxysilyl-modified isocyanurate compound having the formula (3):

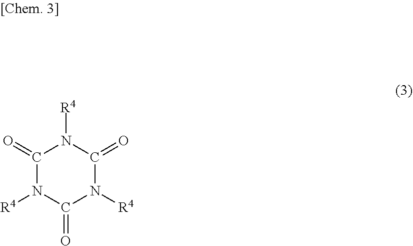

wherein R⁴ is an allyl group or a group having the formula (4):

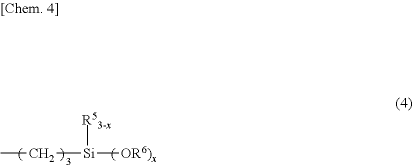

wherein R⁵ is a C₁-C₆ monovalent hydrocarbon group, R⁶ is a C₁-C₄ alkyl group, x is 2 or 3, at least two of R⁴ being groups of formula (4).
[4] The addition-curable silicone rubber composition of any one of [1] to [3] wherein component (A) contains (A-1) an alkenyl-containing organopolysiloxane containing at least two C₂-C₈ alkenyl groups per molecule and having a viscosity of at least 70,000 mPa·s at 25° C. as measured by the method of JIS Z8803:2011.
[5] The addition-curable silicone rubber composition of [4] wherein component (A) further contains (A-2) an alkenyl-containing organopolysiloxane containing at least two C₂-C₈ alkenyl groups per molecule and having a viscosity of 10,000 to 50,000 mPa·s at 25° C. as measured by the method of JIS Z8803:2011.
[6] The addition-curable silicone rubber composition of any one of [1] to [5] wherein component (B) is a cyclic organohydrogenpolysiloxane of formula (1) wherein m=n=2.
[7] The addition-curable silicone rubber composition of any one of [1] to [6] wherein component (C) contains (C-1) an organohydrogenpolysiloxane having at least one silicon-bonded hydrogen atom (SiH group) at each of molecular chain end and side chain.
[8] The addition-curable silicone rubber composition of [7] wherein component (C) further contains at least one of

(C-2) an organohydrogenpolysiloxane having a silicon-bonded hydrogen atom (SiH group) only at a side chain of the molecular chain and

(C-3) an organohydrogenpolysiloxane having a silicon-bonded hydrogen atom

(SiH group) only at an end of the molecular chain.

[9] An airbag comprising a base fabric and a cured film of the addition-curable silicone rubber composition of any one of [1] to [8] thereon.
[10] The airbag of [9] having a hollow weave structure.
[11] The airbag of [9] or [10] for use as a curtain airbag.

### Advantageous Effects of Invention

The airbag, typically curtain airbag, to which the liquid addition-curable silicone rubber composition of the invention is applied, is capable of preventing leakage of inflator gas and sustaining inflation for a sufficient time. The liquid addition-curable silicone rubber composition cures into a cured product which is satisfactory in physical properties including hardness, tensile strength, and elongation at break, as well as adhesion to airbag base fabric.

### DESCRIPTION OF EMBODIMENTS

### <Addition-Curable Silicone Rubber Composition>

The invention provides an addition-curable silicone rubber composition comprising components (A) to (E) defined below, which is liquid at room temperature (25° C.). These components are described below in detail. As used herein, the term “viscosity” refers to a viscosity measured at 25° C. by the method of JIS Z8803:2011, and represents a value measured by a rotational viscometer.

### (A) Alkenyl-Containing Organopolysiloxane

Component (A), which is the base of the inventive composition, is an organopolysiloxane having on the average at least 2 silicon-bonded alkenyl groups per molecule, preferably on the average at most 20, more preferably on the average at most 10 silicon-bonded alkenyl groups per molecule.

The silicon-bonded alkenyl groups are typically of 2 to 8 carbon atoms, preferably 2 to 4 carbon atoms. Examples include vinyl, allyl, propenyl, butenyl, pentenyl, hexenyl, cyclohexenyl, and heptenyl, with vinyl being preferred. The bonding position of silicon-bonded alkenyl group in the organopolysiloxane as component (A) may be a molecular chain end or molecular chain non-end (i.e., molecular chain side chain other than the molecular chain end), or both.

Silicon-bonded organic groups other than the silicon-bonded alkenyl groups include aliphatic unsaturation-free, substituted or unsubstituted monovalent hydrocarbon groups of typically 1 to 12 carbon atoms, preferably 1 to 10 carbon atoms. Examples thereof include alkyl groups such as methyl, ethyl, propyl, isopropyl, isobutyl, tert-butyl, butyl, pentyl, hexyl and heptyl; cycloalkyl groups such as cyclopentyl and cyclohexyl; aryl groups such as phenyl, tolyl, xylyl and naphthyl; aralkyl groups such as benzyl and phenethyl; and halogenated alkyl groups in which hydrogen atom in their functionality is substituted by a halogen atom such as chlorine or fluorine, such as chloromethyl, 3-chloropropyl, and 3,3,3-trifluoropropyl. Preferred are methyl and phenyl.

The content of silicon-bonded alkenyl groups in component (A) is typically 0.001 to 10 mol %, preferably 0.01 to 5 mol % based on the overall silicon-bonded organic groups.

The molecular structure of the organopolysiloxane as component (A) is not particularly limited and may be straight, branched or cyclic. Preferred is a straight diorganopolysiloxane having a backbone consisting essentially of repeating R₂SiO_{2/2} units wherein R is a monovalent hydrocarbon group (i.e., diorganosiloxane units) and capped at both ends of the molecular chain with R₃SiO_{1/2} units wherein R is as defined above (i.e., triorganosiloxy units). As used herein, the term “backbone consisting essentially of R₂SiO_{2/2} units” means that R₂SiO_{2/2} units account for typically 99 to 100 mol %, preferably 99.5 to 100 mol % of the siloxane units constituting the backbone exclusive of both ends of the molecular chain.

In the above formula, R is a monovalent hydrocarbon group which has typically 1 to 12 carbon atoms, preferably 1 to 10 carbon atoms. Examples include those exemplified above for the silicon-bonded alkenyl group, and those exemplified above for the silicon-bonded organic group other than the silicon-bonded alkenyl group.

The organopolysiloxane as component (A) has a viscosity of preferably 100 to 500,000 mPa·s, more preferably 10,000 to 200,000 mPa·s, because the resulting composition is easy to handle and the cured product thereof has satisfactory physical properties including hardness, elongation at break and tensile strength.

Preferably the organopolysiloxane as component (A) has the average compositional formula (5).

[Chem. 5]

R²ₐR³_{b}SiO_{(4-a-b)/2} (5)

Herein R² is independently a C₁-C₁₂ alkyl group or C₆-C₁₂ aryl group, R³ is independently a C₂-C₈ alkenyl group, a is a number of 1.8 to 2.2, preferably 1.9 to 2.0, b is a number of 0.0001 to 0.2, preferably 0.001 to 0.1, and a+b is a number of 1.85 to 2.3, preferably 1.95 to 2.05.

In average compositional formula (5), R² is selected from alkyl groups of 1 to 12 carbon atoms, preferably 1 to 10 carbon atoms and aryl groups of 6 to 12 carbon atoms, preferably 6 to 10 carbon atoms. Examples include those exemplified above for the silicon-bonded organic group other than the silicon-bonded alkenyl group.

In average compositional formula (5), R³ is an alkenyl group, which has typically 2 to 8 carbon atoms, preferably 2 to 4 carbon atoms. Examples include those exemplified above for the silicon-bonded alkenyl group.

Examples of the organopolysiloxane as component (A) include molecular chain both end trimethylsiloxy-capped dimethylsiloxane/methylvinylsiloxane copolymers, molecular chain both end trimethylsiloxy-capped methylvinylpolysiloxane, molecular chain both end trimethoxysiloxy-capped dimethylsiloxane/methylvinylsiloxane/methylphenylsiloxane copolymers, molecular chain both end dimethylvinylsiloxy-capped dimethylpolysiloxane, molecular chain both end dimethylvinylsiloxy-capped methylvinylpolysiloxane, molecular chain both end dimethylvinylsiloxy-capped dimethylsiloxane/methylvinylsiloxane copolymers, molecular chain both end dimethylvinylsiloxy-capped dimethylsiloxane/methylvinylsiloxane/methylphenylsiloxane copolymers, molecular chain both end divinylmethylsiloxy-capped dimethylpolysiloxane, molecular chain both end divinylmethylsiloxy-capped dimethylsiloxane/methylvinylsiloxane copolymers, molecular chain both end trivinylsiloxy-capped dimethylpolysiloxane, molecular chain both end trivinylsiloxy-capped dimethylsiloxane/methylvinylsiloxane copolymers, organosiloxane copolymers consisting of siloxane units of the formula: R²₃SiO_{0.5} (wherein R² is as defined above), siloxane units of the formula: R²₂R³SiO_{0.5} (wherein R³ is as defined above), siloxane units of the formula: R²₂SiO, and siloxane units of the formula: SiO₂, organosiloxane copolymers consisting of siloxane units of the formula: R²₃SiO_{0.5}, siloxane units of the formula: R²₂R³SiO_{0.5}, and siloxane units of the formula: SiO₂, organosiloxane copolymers consisting of siloxane units of the formula: R²₂R³SiO_{0.5}, siloxane units of the formula: R²₂SiO, and siloxane units of the formula: SiO₂, and organosiloxane copolymers consisting of siloxane units of the formula: R²R³SiO and siloxane units of the formula: R²SiO_{1.5} or siloxane units of the formula: R³SiO_{1.5}.

The organopolysiloxane as component (A) may be used alone or in admixture.

On use of a mixture of two or more organopolysiloxanes, component (A) preferably contains (A-1) an alkenyl-containing organopolysiloxane containing at least two C₂-C₈ alkenyl groups per molecule and having a viscosity at 25° C. of at least 70,000 mPa·s, especially 80,000 to 120,000 mPa·s as measured by the method of JIS Z8803:2011 and more preferably in combination with (A-2) an alkenyl-containing organopolysiloxane containing at least two C₂-C₈ alkenyl groups per molecule and having a viscosity at 25° C. of 10,000 to 50,000 mPa·s, especially 20,000 to 40,000 mPa·s as measured by the method of JIS Z8803:2011. A blend ratio of (A-1) to (A-2) preferably ranges from 1/9 to 9/1 in weight ratio. A mixture in the range is satisfactory in preventing leakage of inflator gas and sustaining inflation for a certain time. The resulting liquid addition-curable silicone rubber composition cures into a cured product which is satisfactory in physical properties including hardness, tensile strength, and elongation at break, as well as adhesion to airbag base fabric. Thus the liquid addition-curable silicone rubber composition is fully compatible with airbag fabric.

### (B) Cyclic Organohydrogenpolysiloxane

Component (B) is a cyclic organohydrogenpolysiloxane. It is a component that functions to extend the molecular chain length of component (A) upon curing of the resulting composition and contributes to an improvement in the sustainment of airbag inflation time. Since interaction under the impetus of intermolecular forces occurs between alkyl or aryl groups in its molecule and polymer molecules in the airbag base fabric such as nylon 66, nylon 6, polyester fibers, aramid fibers, polyamide fibers or polyester fibers, it is also a component that improves the adhesion of the composition to the base fabric.

The cyclic organohydrogenpolysiloxane has a molecular structure of the formula (1).

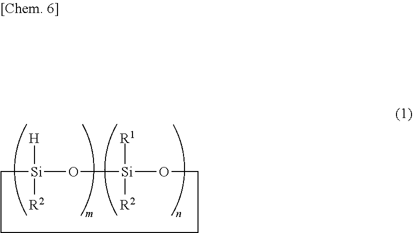

Herein R¹ is a C₁-C₁₂ alkyl group, R² is a C₁-C₁₂ alkyl group or C₆-C₁₂ aryl group, m is an integer of 1 to 3, n is an integer of 1 to 3, m+n is 4 or 5. The organohydrogenpolysiloxane of formula (1) wherein m=2 is present in an amount of at least 50 mol % based on the total amount of component (B).

In formula (1), R¹ is an alkyl group of 1 to 12 carbon atoms, preferably 1 to 8 carbon atoms. Examples include methyl, ethyl, propyl, isopropyl, isobutyl, tert-butyl, butyl, pentyl, hexyl and heptyl, with methyl and isopropyl being preferred.

In formula (1), R² is selected from alkyl groups of 1 to 12 carbon atoms, preferably 1 to 8 carbon atoms and aryl groups of 6 to 12 carbon atoms, preferably 6 to 8 carbon atoms. Examples include those exemplified above for the silicon-bonded organic group other than the silicon-bonded alkenyl group in component (A).

The cyclic organohydrogenpolysiloxane as component (B) is blended in an amount as described later in conjunction with component (C). The cyclic organohydrogenpolysiloxane as component (B) may be used alone or in admixture.

### (C) Organohydrogenpolysiloxane

Component (C) is an organohydrogenpolysiloxane having at least two silicon-bonded hydrogen atoms per molecule, represented by the average compositional formula (2):

[Chem. 7]

R²ₑH_{f}SiO_{(4-e-f)/2} (2)

wherein R² is selected from a C₁-C₁₂ alkyl group and C₆-C₁₂ aryl group, e is a number of 0.7 to 2.1, f is a number of 0.001 to 1.0, and e+f is a number of 0.8 to 2.7, preferably e is a number of 1.0 to 2.0, f is a number of 0.01 to 1.0, and e+f is a number of 1.1 to 2.5.

The organohydrogenpolysiloxane as component (C) has preferably 2 to 200, more preferably 2 to 100 silicon-bonded hydrogen atoms (i.e., SiH groups) per molecule, and 20 to 100%, preferably 30 to 100% (on number basis) of the SiH groups are present in organohydrogensiloxane units of the formula: R²HSiO_{2/2}. It has a viscosity at 25° C. of 1 to 10,000 mPa·s, preferably 10 to 5,000 mPa·s. Notably the organohydrogenpolysiloxane is free of aliphatic unsaturation in the molecule.

The molecular structure of the organohydrogenpolysiloxane as component (C) is not particularly limited, and may be, for example, linear, branched, or three-dimensional network (exclusive of wholly cyclic one), preferably substantially linear. A cyclic siloxane may be bonded to the molecular chain end. As used herein, the term “substantially linear” structure means that R⁶₂SiO_{2/2} units (wherein R⁶ is independently hydrogen or R²) account for typically 99 to 100 mol %, preferably 99.5 to 100 mol % of the siloxane units constituting the backbone exclusive of molecular chain both ends (in case of a cyclic siloxane being bonded thereto, the cyclic siloxane).

In the molecule of organohydrogenpolysiloxane (C), the silicon-bonded hydrogen atom may be positioned at a molecular chain end or a molecular chain non-end or both. When a cyclic siloxane is bonded to the molecular chain end, the silicon-bonded hydrogen atom may be positioned in the cyclic siloxane.

Examples of the organohydrogenpolysiloxane as component (C) include those containing R²HSiO_{2/2} units (wherein R² is as defined above), and optionally R²₂R⁶SiO₁₁₂ units (wherein R⁶ is as defined above) and/or R²₂SiO_{2/2} units in the molecule.

Illustrative examples of the organohydrogenpolysiloxane as component (C) include 1,3,5,7-tetramethylcyclotetrasiloxane, methylhydrogencyclopolysiloxane, methylhydrogensiloxane/dimethylsiloxane cyclic copolymers, both end trimethylsiloxy-capped methylhydrogenpolysiloxane, both end trimethylsiloxy-capped dimethylsiloxane/methylhydrogensiloxane copolymers, both end dimethylhydrogensiloxy-capped dimethylsiloxane/methylhydrogensiloxane copolymers, both end trimethylsiloxy-capped methylhydrogensiloxane/diphenylsiloxane copolymers, both end trimethylsiloxy-capped methylhydrogensiloxane/diphenylsiloxane/dimethylsiloxane copolymers, both end trimethylsiloxy-capped methylhydrogensiloxane/methylphenylsiloxane/dimethylsiloxane copolymers, both end dimethylhydrogensiloxy-capped methylhydrogensiloxane/dimethylsiloxane/diphenylsiloxane copolymers, both end dimethylhydrogensiloxy-capped methylhydrogensiloxane/dimethylsiloxane/methylphenylsiloxane copolymers, copolymers consisting of (CH₃)(H)SiO_{2/2} units, (CH₃)₃SiO_{1/2} units and SiO₄₁₂ units, copolymers consisting of (CH₃)(H)SiO_{2/2} units, (CH₃)₂SiO_{2/2} units, (CH₃)₃SiO_{1/2} units and SiO₄₁₂ units, copolymers consisting of (CH₃)(H)SiO_{2/2} units, (CH₃)₂(H)SiO_{1/2} units, (CH₃)₃SiO_{1/2} units and SiO_{4/2} units, and copolymers consisting of (CH₃)(H)SiO_{2/2} units, (CH₃)₂(H)SiO_{1/2} units, (CH₃)₂SiO_{2/2} units, (CH₃)₃SiO_{1/2} units and SiO_{4/2} units. More preferred examples are given below.

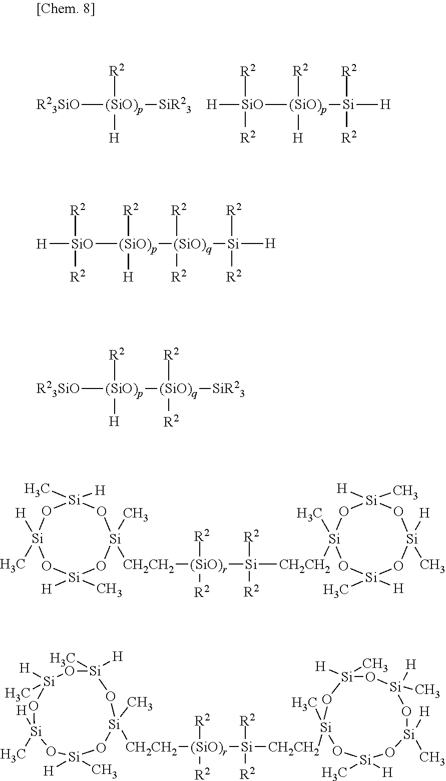

Herein R² is as defined above, p, q and r are independently an integer of at least 1, with the proviso that p, q and r are such integers that the organohydrogenpolysiloxane may have a viscosity at 25° C. of 0.001 to 10 Pa·s, preferably 0.01 to 5 Pa·s.

Amounts of components (B) and (C) blended are such that the total number of silicon atom-bonded hydrogen atoms in components (B) and (C) is 1 to 7 (i.e., a molar ratio of 1/1 to 7/1), preferably 1 to 5, more preferably 1 to 3 per silicon atom-bonded alkenyl group in component (A), and the number (or moles) of silicon atom-bonded hydrogen atoms in component (B) is 1 to 30%, preferably 2 to 20% of the number (or moles) of silicon atom-bonded hydrogen atoms in components (B) and (C). If these numbers (or amounts) are outside the ranges, the air tightness of an airbag during inflation is inferior.

The organohydrogenpolysiloxane as component (C) may be used alone or in admixture.

On use of a mixture of two or more organohydrogenpolysiloxanes, one is preferably (C-1) an organohydrogenpolysiloxane having at least one silicon-bonded hydrogen atom (SiH group) at each of molecular end and side chain. More preferably, component (C) further contains at least one of (C-2) an organohydrogenpolysiloxane having a silicon-bonded hydrogen atom (SiH group) only at a side chain of the molecular chain and (C-3) an organohydrogenpolysiloxane having a silicon-bonded hydrogen atom (SiH group) only at an end of the molecular chain. On use of (C-1) and (C-2) or (C-3), their blend ratio is preferably from 9.99:0.01 to 0.01:9.99 in weight ratio. On use of (C-1), (C-2) and (C-3), their blend ratio is preferably from 9.98:0.01:0.01 to 0.01:5.00:4.99 in weight ratio. These ranges ensure that the composition is effective for preventing leakage of inflator gas and sustaining inflation for a sufficient time. The liquid addition-curable silicone rubber composition cures into a cured product which is satisfactory in physical properties including hardness, tensile strength, and elongation at break, as well as adhesion to airbag base fabric. It is thus useful as a liquid silicone rubber coating composition applicable to airbag base fabric.

### (D) Finely Divided Silica

Component (D) is finely divided silica which serves as a reinforcement, that is, to impart a high tear strength to the cured composition. Use of finely divided silica enables to form a coating layer having improved tear strength. The finely divided silica should have a specific surface area of at least 50 m²/g, preferably 50 to 400 m²/g, and more preferably 100 to 300 m²/g, as measured by the BET method. Silica with a specific surface area of less than 50 m²/g may sometimes fail to impart satisfactory tear strength to the composition.

The finely divided silica as component (D) may be any known silica used as a reinforcing filler for conventional silicone rubber, provided that the silica has a BET specific surface area within the above-indicated range. Exemplary silicas include precipitated silica, fumed silica and fired silica. Although finely divided silica may be used directly without modification, it is advantageous to treat silica with organosilicon compounds to render surfaces hydrophobic because the use of hydrophobic finely divided silica can impart a good flow to the composition. Exemplary organosilicon compounds include hexaorganodisilazanes such as hexamethyldisilazane, divinyltetramethyldisilazane, and dimethyltetravinyldisilazane; alkoxysilanes such as methyltrimethoxysilane, ethyltrimethoxysilane, propyltrimethoxysilane, butyltrimethoxysilane, dimethyldimethoxysilane, diethyldimethoxysilane, vinyltriethoxysilane, vinyltrimethoxysilane, trimethylmethoxysilane, triethylmethoxysilane, vinyltris(methoxyethoxy)silane, and divinyldimethoxysilane; methylchlorosilanes such as trimethylchlorosilane, dimethyldichlorosilane, and methyltrichlorosilane; and dimethylpolysiloxane free of silicon-bonded alkenyl groups and silicon-bonded hydrogen atoms.

The amount of component (D) compounded is 0.1 to 50 parts by weight, preferably 1 to 50 parts by weight, and more preferably 5 to 40 parts by weight per 100 parts by weight of the organopolysiloxane (A). Too less amounts may fail to provide the desired tear strength whereas too much amounts may compromise the flow of the composition, making the coating operation difficult.

The finely divided silica as component (D) may be used alone or in admixture.

### (E) Addition Reaction Catalyst

Component (E) is an addition reaction catalyst, which promotes the addition reaction between silicon-bonded alkenyl groups in component (A) and SiH groups in components (B) and (C). Although the addition reaction catalyst is not particularly limited, suitable catalysts include, for example, platinum group metals such as platinum, palladium, and rhodium; chloroplatinic acid; alcohol-modified chloroplatinic acid; coordination compounds of chloroplatinic acid with olefins, vinylsiloxane or acetylene compounds; platinum group metal compounds such as tetrakis(triphenylphosphine)palladium and chlorotris(triphenylphosphine)rhodium. The platinum group metal compounds are preferred.

Component (E) may be compounded in a catalytic amount, preferably in an amount of 1 to 500 ppm, and more preferably 10 to 100 ppm, expressed as the weight of catalyst metal element based on the total weight of components (A) to (C). If the amount is too less, the addition reaction may become very slow, or the composition may not cure. If the amount is too much, the cured composition may have poor heat resistance.

The addition reaction catalyst as component (E) may be used alone or in admixture.

While the addition curable silicone rubber composition contains components (A) to (E) as essential components, the following components may be further added.

### (F) Tackifier

Component (F) is a tackifier, which is effective for improving the adhesion of the composition to synthetic fiber woven fabric bases, non-woven fabric bases, thermoplastic resin sheets or film bases for airbags. The tackifier is not particularly limited as long as it can improve the self-adhesion of the composition. Exemplary tackifiers include organosilicon compound-based tackifiers and non-silicon organic compound-based tackifiers. Specifically, suitable organosilicon compound-based tackifiers include tackifiers composed of organosilicon compounds such as organosilanes and organopolysiloxanes other than components (A) to (C), and suitable non-silicon organic compound-based tackifiers include tackifiers composed of organic acid allyl esters and epoxy ring-opening catalysts. These catalysts may be used alone or in admixture.

The organic acid allyl esters are esters containing no silicon atom in the molecule, for example, organic acid allyl esters having one allyl group and at least one ester group in the molecule. Exemplary organic acids include unsaturated carboxylic acids such as acrylic acid, methacrylic acid, and vinylacetic acid; aromatic carboxylic acids such as benzoic acid, phthalic acid, pyromellitic acid; and saturated fatty acids such as acetic acid, propionic acid, butyric acid and lauric acid. Suitable allyl esters of these organic acids include, for example, allyl esters of unsaturated carboxylic acids such as acrylic acid, methacrylic acid, and vinylacetic acid; allyl esters of aromatic carboxylic acids such as allyl benzoate, diallyl phthalate, tetraallyl pyromellitate; and allyl esters of saturated fatty acids such as allyl acetate, allyl propionate, allyl butyrate, allyl valerate, and allyl laurate.

The epoxy ring-opening catalysts are catalysts containing no silicon atom in the molecule, for example, epoxy ring-opening catalysts of organic metal chelate, amine, amide, imidazole, and acid anhydride types.

Suitable organosilicon compounds include organosilanes having at least one functional group, preferably at least two functional groups selected from silicon-bonded alkenyl groups such as vinyl and allyl, an epoxy group bonded to a silicon atom via a carbon atom in an alkylene group optionally containing at least one ether bonding oxygen atom such as γ-glycidoxypropyl and β-(3,4-epoxycyclohexyl)ethyl; acryloxy and methacryloxy groups bonded to a silicon atom via a carbon atom in an alkylene group such as γ-acryloxypropyl and γ-methacryloxypropyl; alkoxy groups such as methoxy, ethoxy, propoxy, and butoxy; alkoxysilyl groups bonded to a silicon atom via an alkylene group and optionally containing one or two ester structures, urethane structures, or ether structures such as trimethoxysilyl, triethoxysilyl and methyldimethoxysilyl; isocyanate groups; and SiH groups; linear or cyclic siloxane oligomers of 3 to 100, preferably 3 to 50, more preferably 5 to 20 silicon atoms, other than components (A) to (C); (alkoxy)silyl-modified compounds of triallyl isocyanurate and siloxane derivatives thereof, with the compounds having at least two functional groups per molecule being preferred.

Preferably, the composition contains as component (F) an alkoxysilyl-modified isocyanurate compound having the formula (3):

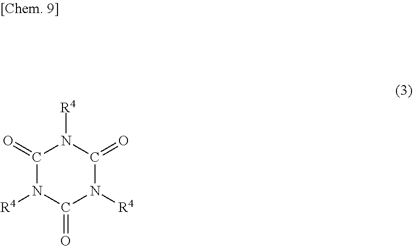

wherein R⁴ is an allyl group or a group having the formula (4):

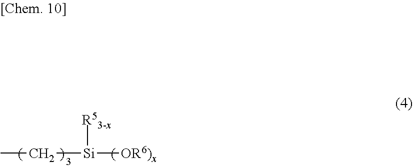

wherein R⁵ is a C₁-C₆ monovalent hydrocarbon group, R⁶ is a C₁-C₄ alkyl group, and x is 2 or 3, at least two of groups R⁴ being groups of formula (4).

Examples of the organosilicon compound are given below.

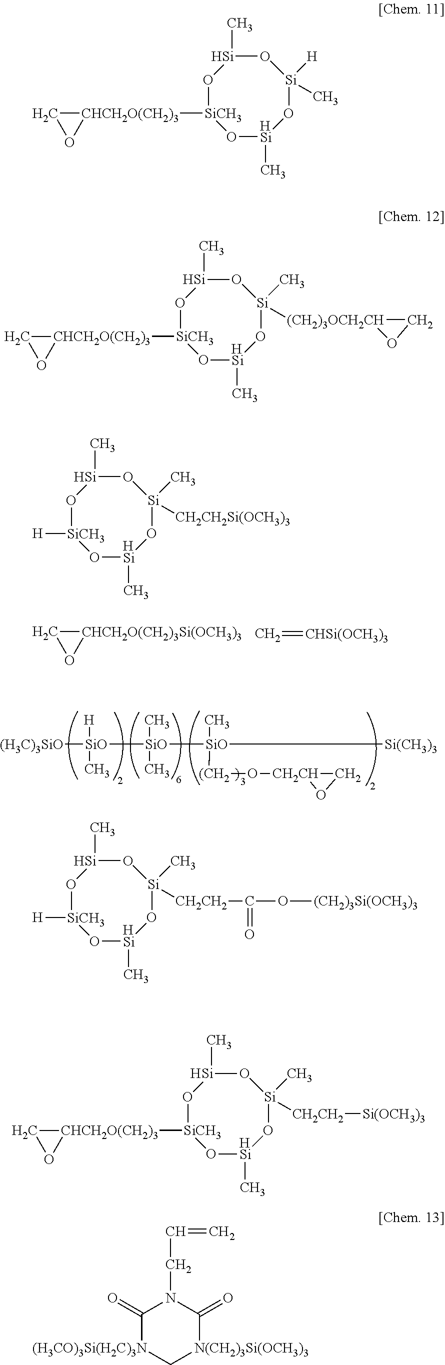

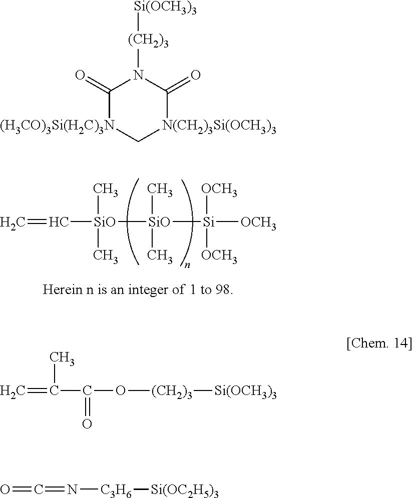

Component (F) is compounded in an amount of 0.05 to 5 parts by weight, preferably 0.1 to 2 parts by weight per 100 parts by weight of the organopolysiloxane as component (A). If the amount is too less, the composition may not be fully adhesive. Too much amounts add to the cost, rendering the composition uneconomical.

The tackifier as component (F) may be used alone or in admixture.

### (G) Condensation Catalyst

Component (G) is a condensation catalyst, which is at least one compound selected from organotitanium compounds and organozirconium compounds and which functions as a condensation co-catalyst for component (F) for promoting adhesion. Component (G) may be used alone or in admixture. Exemplary of component (G) are titanium-based condensation co-catalysts including organic titanic acid esters such as titanium tetraisopropoxide, titanium tetra-n-butoxide and titanium tetra-2-ethylhexoxide, and organic titanium chelate compounds such as titanium diisopropoxy(acetylacetonate), titanium diisopropoxybis(ethylacetoacetate) and titanium tetraacetylacetonate; and zirconium-based condensation co-catalysts including organic zirconium esters such as zirconium tetra-n-propoxide and zirconium tetra-n-butoxide, and organic zirconium chelate compounds such as zirconium tributoxymonoacetylacetonate, zirconium monobutoxyacetylacetonate bis(ethylacetoacetate), and zirconium tetraacetylacetonate.

Component (G), organotitanium compound or organozirconium compound is an optional component which is blended if necessary. The amount of component (G) blended is typically up to about 5 parts by weight (0 to 5 parts by weight) per 100 parts by weight of component (A), and when used, 0.1 to 5 parts by weight and more preferably 0.2 to 2 parts by weight. If the amount is less than 0.1 part by weight, the cured composition may experience a loss of adhesion permanence under hot humid conditions. If the amount is more than 5 parts by weight, the cured composition is likely to lose heat resistance.

### Other Components

Besides the foregoing components (A) to (G), the composition of the invention may further include other optional components as long as the object of the invention is not compromised. Examples of the other components are given below. Each of the other components may be used alone or in admixture.

⋅Reaction inhibitor

The reaction inhibitor is not particularly limited as long as it is a compound having a cure reaction inhibiting effect on the addition reaction catalyst. Any of inhibitors which are well known in the art may be used. Examples of such inhibitor include phosphorus-containing compounds such as triphenylphosphine, nitrogen-containing compounds such as tributylamine, tetramethylethylenediamine and benzotriazole, sulfur-containing compounds, acetylene compounds such as acetylene alcohols, compounds having two or more alkenyl groups, hydroperoxy compounds, and malic acid derivatives. The extent of the cure-retarding effect achieved by the inhibitor varies according to the chemical structure of the inhibitor. It is thus preferable to adjust the amount of inhibitor included in the composition so as to be optimal for a particular inhibitor compound used. By blending an appropriate amount of the inhibitor, the composition is improved in long-term shelf stability at room temperature and curability.

⋅Inorganic or organic filler

Besides the finely divided silica as component (D) such as precipitated silica, fumed silica and fired silica, the composition of the invention may have further added thereto inorganic or organic fillers as described below. Exemplary inorganic fillers include crystalline silica, hollow fillers, silsesquioxane, fumed titanium dioxide, magnesium oxide, zinc oxide, iron oxide, aluminum hydroxide, magnesium carbonate, calcium carbonate, zinc carbonate, laminar mica, carbon black, diatomaceous earth, and glass fibers; inorganic fillers which are treated with organosilicon compounds such as organoalkoxysilane compounds, organochlorosilane compounds, organosilazane compounds and low-molecular-weight siloxane compounds, to render the surface hydrophobic; silicone rubber powders; silicone resin powders, etc.

⋅Other Components

Besides, optional components may be further included, for example, organopolysiloxanes having on the molecule one silicon-bonded hydrogen atom and bearing no other functional groups (e.g., functional groups listed above for the organosilicon compounds), organopolysiloxanes having neither silicon-bonded hydrogen atoms nor silicon-bonded alkenyl groups, solvents such as water and organic solvents, creep hardening inhibitors, plasticizers, thixotropic agents, pigments, dyes and mildew-proofing agents.

### Preparation Conditions

The preparation conditions, curing method and curing conditions of the inventive composition may be well-known preparation conditions, curing method and curing conditions. Typical curing conditions include 120 to 200° C. and 1 to 10 minutes.

### <Airbag>

The composition of the invention is advantageously used in airbags, especially curtain airbags. Airbags, on which a silicone rubber coating layer is formed of a cured product of the composition, may be of well-known construction, for example, of hollow weave structure having a silicone rubber coating layer formed thereon. Exemplary of the airbag are airbags of hollow weave structure including a base fabric which is a woven fabric made of synthetic fibers such as nylon 66, nylon 6, polyester fibers, aramid fibers, various polyamide fibers and various polyester fibers.

In the preparation of such airbags, a conventional method may be used to coat the composition onto the base fabric. The thickness of a coating layer (or surface coating weight) is, for example, about 10 to 150 g/m², preferably about 15 to 80 g/m², and most preferably about 20 to 60 g/m² in dry state.

### EXAMPLES

Examples and Comparative Examples are given below for illustrating the invention, but the invention is by no means limited thereto. Notably, all parts are by weight. The viscosity is a value measured at 25° C. by the method of JIS Z8803:2011.

### Example 1

On a kneader, 60 parts of molecular chain both end vinyldimethylsiloxy-capped dimethylpolysiloxane having a viscosity of about 30,000 mPa·s, 8 parts of hexamethyldisiloxane, 2 parts of water, and 40 parts of finely divided silica having a specific surface area of about 300 m²/g by the BET method (tradename: Aerosil 300, Nippon Aerosil Co., Ltd.) were mixed for 1 hour. Thereafter, the temperature in the kneader was elevated to 150° C., followed by 2 hours of mixing. Then the temperature was lowered to 100° C., after which 30 parts of molecular chain both end vinyldimethylsiloxy-capped dimethylpolysiloxane having a viscosity of about 30,000 mPa·s was added. The ingredients were mixed until uniform, obtaining Base Compound I.

Composition 1 was prepared by mixing 108 parts of Base Compound I with 62.4 parts of molecular chain both end vinyldimethylsiloxy-capped dimethylpolysiloxane having a viscosity of about 100,000 mPa·s, 0.2 part of cyclic organohydrogenpolysiloxane shown below as Compound 1 (silicon-bonded hydrogen atom content=0.62 wt %), 11.5 parts of dimethylsiloxane/methylhydrogensiloxane copolymer capped at molecular chain both ends with dimethylhydrogensiloxy, containing silicon-bonded hydrogen atoms at both ends and non-end positions of the molecular chain, and having a viscosity of 90 mPa·s (silicon-bonded hydrogen atom content=0.06 wt %), 0.10 part of dimethylsiloxane/methylhydrogensiloxane copolymer capped at molecular chain both ends with trimethylsiloxy, containing silicon-bonded hydrogen atoms on side chains of the molecular chain, and having a viscosity of 45 mPa·s (silicon-bonded hydrogen atom content=1.08 wt %), 0.25 part of alkoxysilyl-modified isocyanurate compound shown below as Compound 2, 0.30 part of γ-glycidoxypropyltrimethoxysilane shown below as Compound 3, 0.15 part of 1-ethynylcyclohexanol, 0.20 part of a dimethylpolysiloxane solution of chloroplatinic acid/1,3-divinyltetramethyldisiloxane complex having a platinum atom content of 1 wt %, and 0.26 part of zirconium tetraacetylacetonate.

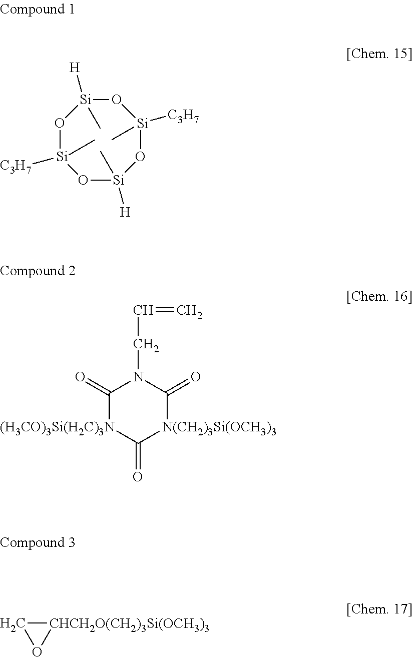

Notably, in Composition 1, the total number of silicon-bonded hydrogen atoms in components (B) and (C) was 1.5 per silicon-bonded alkenyl group in component (A), and the number of silicon-bonded hydrogen atoms in component (B) was 13% based on the total number of silicon-bonded hydrogen atoms in components (B) and (C).

The results including H/V and the molar ratio (in %) of silicon-bonded hydrogen atoms in component (B) are shown in Table 1. It is noted that H/V is a molar ratio of the total of silicon-bonded hydrogen atoms in components (B) and (C) to silicon-bonded alkenyl groups in component (A). The molar ratio (in %) of silicon-bonded hydrogen atoms in component (B) is a molar ratio (in %) of silicon-bonded hydrogen atoms in component (B) to the total of silicon-bonded hydrogen atoms in components (B) and (C).

Composition 1 was cured by heating at 150° C. for 5 minutes. A test sheet was prepared therefrom according to JIS K6249:2003. The test sheet was measured for hardness, tensile strength and elongation at break.

Separately, Composition 1 was coated onto a hollow-weave airbag base fabric of nylon 66 (210 deniers) with a coater to a coating weight of 50 g/m² which was the minimum coating weight capable of uniform coating without variations, and heat cured in an oven at 200° C. for 1 minute, yielding a hollow weave airbag. This airbag was subjected to an air tightness test. In the air tightness test, the airbag was inflated under a pressure of 100 kPa, and the residual pressure after 30 seconds was measured. Air tightness was evaluated in terms of the measured value.

### <Scott Type Crumpling Test>

The composition was coated onto an airbag base fabric of nylon 66 (210 deniers) in a coating weight of 50 g/m² and heated at 200° C. for 1 minute. On this coated fabric, a Scott type crumpling test was carried out.

The Scott type crumpling test was carried out according to the method of JIS K6404-6:1999, using a Scott type crumpling tester (Scott type crumple-flex abrasion tester, Toyo Seiki Co., Ltd.). The silicone rubber-coated nylon fabric was subjected to 500 cycles of the Scott type crumpling test under a loading pressure of 19.6 N, after which the coating was visually observed for breakage. The sample was rated “pass” when the silicone rubber coating layer did not peel from the coated surface, and “reject” when peeled.

### Example 2

Composition 2 was prepared by mixing 108 parts of Base Compound I in Example 1 with 62.4 parts of molecular chain both end vinyldimethylsiloxy-capped dimethylpolysiloxane having a viscosity of about 100,000 mPa·s, 0.24 part of cyclic organohydrogenpolysiloxane shown below as Compound 4 (silicon-bonded hydrogen atom content=0.51 wt %), 11.5 parts of dimethylsiloxane/methylhydrogensiloxane copolymer capped at molecular chain both ends with dimethylhydrogensiloxy, containing silicon-bonded hydrogen atoms at both ends and non-end positions of the molecular chain, and having a viscosity of 90 mPa·s (silicon-bonded hydrogen atom content=0.06 wt %), 0.10 part of dimethylsiloxane/methylhydrogensiloxane copolymer capped at molecular chain both ends with trimethylsiloxy, containing silicon-bonded hydrogen atoms at side chains of the molecular chain, and having a viscosity of 45 mPa·s (silicon-bonded hydrogen atom content=1.08 wt %), 0.25 part of alkoxy-modified isocyanurate compound shown below as Compound 5, 0.30 part of γ-glycidoxypropyltrimethoxysilane shown below as Compound 3, 0.15 part of 1-ethynylcyclohexanol, 0.20 part of a dimethylpolysiloxane solution of chloroplatinic acid/1,3-divinyltetramethyldisiloxane complex having a platinum atom content of 1 wt %, and 0.26 part of zirconium tetraacetylacetonate.

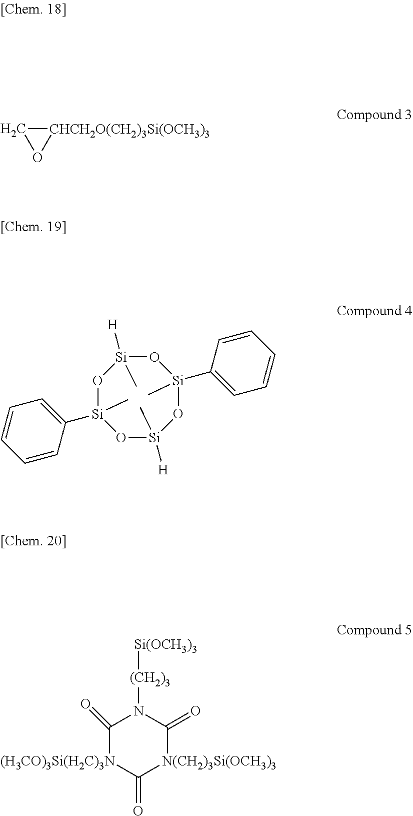

Notably, in Composition 1, the total number of silicon-bonded hydrogen atoms in components (B) and (C) was 1.5 per silicon-bonded alkenyl group in component (A), and the number of silicon-bonded hydrogen atoms in component (B) was 13% based on the total number of silicon-bonded hydrogen atoms in components (B) and (C).

As in Example 1, a test sheet, a hollow weave airbag, and a coated base fabric were prepared and tested. The results are also shown in Table 1.

### Comparative Example 1

Composition 3 was prepared by mixing 108 parts of Base Compound I in Example 1 with 62.4 parts of molecular chain both end vinyldimethylsiloxy-capped dimethylpolysiloxane having a viscosity of about 100,000 mPa·s, 0.94 part of dimethylpolysiloxane containing one silicon-bonded hydrogen atom in the form of a dimethylhydrogensiloxy group at each end of the molecular chain and having a viscosity of 18 mPa·s (silicon-bonded hydrogen atom content=0.13 wt %), 11.5 parts of dimethylsiloxane/methylhydrogensiloxane copolymer capped at molecular chain both ends with dimethylhydrogensiloxy, containing silicon-bonded hydrogen atoms at both ends and non-end positions of the molecular chain, and having a viscosity of 90 mPa·s (silicon-bonded hydrogen atom content=0.06 wt %), 0.10 part of dimethylsiloxane/methylhydrogensiloxane copolymer capped at molecular chain both ends with trimethylsiloxy, containing silicon-bonded hydrogen atoms on side chains of the molecular chain, and having a viscosity of 45 mPa·s (silicon-bonded hydrogen atom content=1.08 wt %), 0.25 part of alkoxysilyl-modified isocyanurate compound shown below as Compound 2, 0.30 part of γ-glycidoxypropyltrimethoxysilane shown below as Compound 3, 0.15 part of 1-ethynylcyclohexanol, 0.20 part of a dimethylpolysiloxane solution of chloroplatinic acid/1,3-divinyltetramethyldisiloxane complex having a platinum atom content of 1 wt %, and 0.26 part of zirconium tetraacetylacetonate.

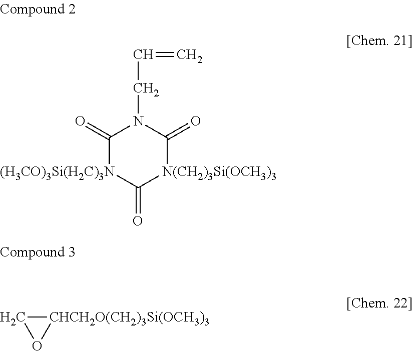

Notably, in Composition 1, the total number of silicon-bonded hydrogen atoms in components (B) and (C) was 1.5 per silicon-bonded alkenyl group in component (A), and the number of silicon-bonded hydrogen atoms in component (B) was 0% based on the total number of silicon-bonded hydrogen atoms in components (B) and (C).

As in Example 1, a test sheet, a hollow weave airbag, and a coated base fabric were prepared and tested. The results are also shown in Table 1.

### Comparative Example 2

Composition 4 was prepared by mixing 108 parts of Base Compound I in Example 1 with 62.4 parts of molecular chain both end vinyldimethylsiloxy-capped dimethylpolysiloxane having a viscosity of about 100,000 mPa·s, 13.5 parts of dimethylsiloxane/methylhydrogensiloxane copolymer capped with dimethylhydrogensiloxy at both ends of the molecular chain, containing silicon-bonded hydrogen atoms at both ends and non-end positions of the molecular chain and having a viscosity of 90 mPa·s (silicon-bonded hydrogen atom content=0.06 wt %), 0.10 part of dimethylsiloxane/methylhydrogensiloxane copolymer capped at molecular chain both ends with trimethylsiloxy, containing silicon-bonded hydrogen atoms on side chains of the molecular chain, and having a viscosity of 45 mPa·s (silicon-bonded hydrogen atom content=1.08 wt %), 0.25 part of alkoxysilyl-modified isocyanurate compound shown below as Compound 2, 0.30 part of γ-glycidoxypropyltrimethoxysilane shown below as Compound 3, 0.15 part of 1-ethynylcyclohexanol, 0.20 part of a dimethylpolysiloxane solution of chloroplatinic acid/1,3-divinyltetramethyldisiloxane complex having a platinum atom content of 1 wt %, and 0.26 part of zirconium tetraacetylacetonate.

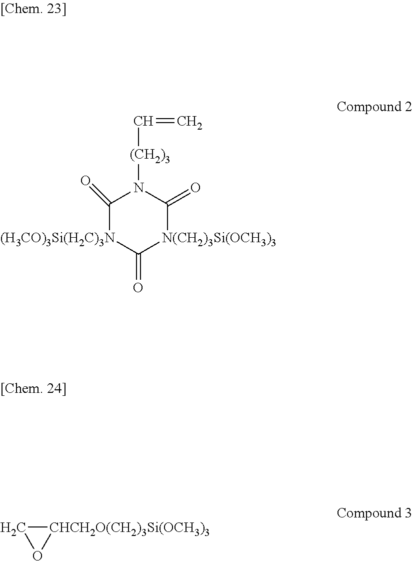

Notably, in Composition 1, the total number of silicon-bonded hydrogen atoms in components (B) and (C) was 1.5 per silicon-bonded alkenyl group in component (A), and the number of silicon-bonded hydrogen atoms in component (B) was 0% based on the total number of silicon-bonded hydrogen atoms in components (B) and (C).

As in Example 1, a test sheet, a hollow weave airbag, and a coated base fabric were prepared and tested. The results are also shown in Table 1.

TABLE 1

| | | | Comparative | Comparative |
|---|---|---|---|---|
| | Example 1 | Example 2 | Example 1 | Example 2 |
| Hardness | 7 | 6 | 7 | 10 |
| (Durometer Type A) | | | | |
| Tensile strength | 4.0 | 3.5 | 3.0 | 4.8 |
| (MPa) | | | | |
| Elongation at | 1,500 | 1,490 | 1,420 | 1,300 |
| break (%) | | | | |
| H/V | 1.5 | 1.5 | 1.5 | 1.5 |
| Ratio of hydrogen | 13 | 13 | 0 | 0 |
| atom in (B) | | | | |
| Air tightness (kPa) | 80 | 75 | 30 | 10 |
| Scott type | Pass | Pass | Reject | Reject |
| crumpling test | | | | |

1. An addition-curable silicone rubber composition comprising:
(A) 100 parts by weight of an organopolysiloxane having at least two C₂-C₈ alkenyl groups per molecule,
(B) a cyclic organohydrogenpolysiloxane having the formula (1): 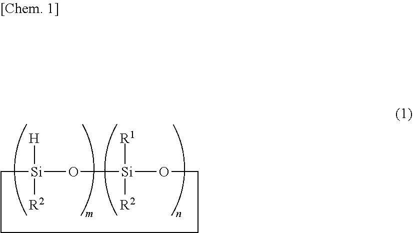
wherein R¹ is a C₁-C₁₂ alkyl group, R² is a C₁-C₁₂ alkyl group or C₆-C₁₂ aryl group, m is an integer of 1 to 3, n is an integer of 1 to 3, m+n is 4 or 5, the organohydrogenpolysiloxane of formula (1) wherein m=2 being present in an amount of at least 50 mol % based on the total amount of component (B),
(C) an organohydrogenpolysiloxane having at least two silicon-bonded hydrogen atoms per molecule, represented by the average compositional formula (2):
[Chem. 2]
R²ₑH_{f}SiO_{(4-e-f)/2} (2)
wherein R² is as defined above, e is a number of 0.7 to 2.1, f is a number of 0.001 to 1.0, e+f is a number of 0.8 to 2.7,
the amounts of components (B) and (C) blended being such that the total number of silicon-bonded hydrogen atoms in components (B) and (C) is 1 to 7 per silicon-bonded alkenyl group in component (A), and the number of silicon-bonded hydrogen atoms in component (B) is 1 to 30% based on the total number of silicon-bonded hydrogen atoms in components (B) and (C),
(D) 0.1 to 50 parts by weight of finely divided silica having a specific surface area of at least 50 m²/g as measured by the BET method, and
(E) a catalytic amount of an addition reaction catalyst.

2. The addition-curable silicone rubber composition of claim 1, further comprising
(F) a tackifier, and
(G) at least one condensation catalyst selected from organotitanium compounds and organozirconium compounds.

3. The addition-curable silicone rubber composition of claim 2 wherein component (F) contains an alkoxysilyl-modified isocyanurate compound having the formula (3): 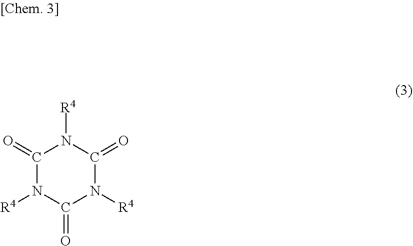
wherein R⁴ is an allyl group or a group having the formula (4): 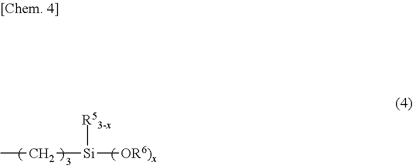
wherein R⁵ is a C₁-C₆ monovalent hydrocarbon group, R⁶ is a C₁-C₄ alkyl group, x is 2 or 3, at least two of R⁴ being groups of formula (4).

4. The addition-curable silicone rubber composition of any one of claims 1 to 3 wherein component (A) contains (A-1) an alkenyl-containing organopolysiloxane containing at least two C₂-C₈ alkenyl groups per molecule and having a viscosity of at least 70,000 mPa·s at 25° C. as measured by the method of JIS Z8803:2011.

5. The addition-curable silicone rubber composition of claim 4 wherein component (A) further contains (A-2) an alkenyl-containing organopolysiloxane containing at least two C₂-C₈ alkenyl groups per molecule and having a viscosity of 10,000 to 50,000 mPa·s at 25° C. as measured by the method of JIS Z8803:2011.

6. The addition-curable silicone rubber composition of claim 1 wherein component (B) is a cyclic organohydrogenpolysiloxane of formula (1) wherein m=n=2.

7. The addition-curable silicone rubber composition of claim 1 wherein component (C) contains (C-1) an organohydrogenpolysiloxane having at least one silicon-bonded hydrogen atom (SiH group) at each of molecular chain end and side chain.

8. The addition-curable silicone rubber composition of claim 7 wherein component (C) further contains at least one of
(C-2) an organohydrogenpolysiloxane having a silicon-bonded hydrogen atom (SiH group) only at a side chain of the molecular chain and
(C-3) an organohydrogenpolysiloxane having a silicon-bonded hydrogen atom (SiH group) only at an end of the molecular chain.

9. An airbag comprising a base fabric and a cured film of the addition-curable silicone rubber composition of claim 1 thereon.

10. The airbag of claim 9 having a hollow weave structure.

11. The airbag of claim 9 or 10 for use as a curtain airbag.
